(19) United States
(12) Patent Application Publication
(10) Pub. No.: US 2011/0248454 A1
(43) Pub. Date: Oct. 13, 2011

(54) GASKET MOUNTING SYSTEM AND METHOD

(76) Inventor: Kenneth R. Bertram, Massillon, OH (US)

(21) Appl. No.: 13/071,410

(22) Filed: Mar. 24, 2011

Related U.S. Application Data
(60) Provisional application No. 61/317,267, filed on Mar. 24, 2010.

(51) Int. Cl. F16J 15/06; B23P 11/00; F16J 15/02

(52) U.S. Cl. 277/641; 29/428; 29/525.01

(57) ABSTRACT

A gasket is adapted to be mounted to a structure with a connector having a head and a body. The gasket includes a sealing body and a mounting body secured to the sealing body. The mounting body defines an elongated hollow chamber adapted to receive the head of the connector that mounts the gasket to the structure.

### CROSS REFERENCE TO RELATED APPLICATIONS

This application claims the benefit of U.S. provisional application 61/317,267 filed Mar. 24, 2010; the disclosures of which are incorporated herein by reference.

### BACKGROUND OF THE INVENTION

1. Technical Field

The present invention generally relates to gaskets and seals. More particularly, the invention relates to a multiple component gasket wherein the gasket includes a softer sealing body connected to a channel-shaped mounting body that receives the head of a push-in connector or “Christmas tree” connector with the body of the connector extending outwardly from the mounting body such that the gasket may be secured to a structure. The invention also relates to a method for mounting a gasket to a structure.

2. Background Information

Many gaskets are mounted to a structure with push-in connectors or commonly-named “Christmas tree” connectors that are pushed into openings in the structure. These connectors are also referred to as clips in the art. A push-in connector or Christmas tree connector has a head and a body wherein the body includes plurality of angled locking fingers adapted to collapse toward the body when the connector is pushed through a hole and then spring back outwardly to prevent the connector from being pulled back out of the hole. These connectors are typically pushed into holes that are drilled or otherwise formed in the gasket such that the bodies of the connectors extend from the gasket while the head of the connector is held in the body of the gasket. The gasket is secured to a structure by pushing the connector bodies into openings defined by the structure to which the gasket is being mounted. Drawbacks with this connection configuration include the need to space the holes in the gasket at the exact same spacing of the openings defined by the structure to which the gasket is being mounted. The holes in the gasket are thus typically drilled or punched manually which is time consuming and expensive. Another drawback is that the position of the gasket cannot be adjusted after it is installed.

### BRIEF SUMMARY OF THE INVENTION

The invention provides a gasket having a sealing body connected to a channel-shaped mounting body or a mounting body that defines an elongated channel that receives the head of a push-in connector that may be used to mount the gasket to a structure.

The mounting body may be fabricated from a material that is more rigid than the material of the sealing body of the gasket.

The channel of the mounting body may be continuous so that the gasket may slide along a connector head or a plurality of connector heads so that the position of the gasket may be adjusted with respect to the structure to which it is being mounted. The adjustment may occur after the connectors are secured to the structure.

Connectors may be slid in the end of the channel in the mounting body such that a plurality of connectors may be pre-loaded but not positioned. The connectors also may be added to the mounting body by inserting the head of the connector through the bottom opening of the channel and then twisting the head to prevent it from falling out of the mounting body. The person installing the gasket may reposition the connectors to desired locations depending on the locations of the openings in the structure. The person also may add connectors to the gasket or remove connectors as needed.

In another configuration, the invention provides a mounting structure that has preinstalled or integral connectors. The gasket has the mounting channel that may be slid over the connectors to secure the gasket to the structure.

In one configuration of the invention, the sealing body of the gasket is formed from EPDM while the mounting body of the gasket is formed from polyethylene or polypropylene.

The invention also provides a method of mounting a gasket to a structure having a plurality of preinstalled connectors with each connector having a body and a head. The method includes the steps of: providing a gasket having a sealing body; the sealing body being made from a first material; a mounting body secured to the sealing body; the mounting body defining an elongated hollow chamber; and the mounting body being made from a second material different from the first material; and sliding the mounting body over the heads of the preinstalled connectors to position the heads of the connectors in the elongated hollow chamber.

The invention also provides a method of mounting a connector to a gasket including the steps of: providing a gasket having a sealing body; the sealing body being made from a first material; a mounting body secured to the sealing body; the mounting body defining an elongated hollow chamber with an elongated opening; and the mounting body being made from a second material different from the first material; providing a connector having a head and a body; inserting the head of the connector through the opening into the elongated hollow chamber with at least a portion of the body of the connector projecting from the mounting body; and twisting the connector to connect the connector to the gasket.

### BRIEF DESCRIPTION OF THE SEVERAL VIEWS OF THE DRAWINGS

FIG. 1 is a perspective view of a prior art push-in connector or Christmas-tree connector that may be used with the gasket of the invention.

FIG. 2 is a schematic section view showing the end of a prior art gasket showing the location of the push-in connector.

FIG. 3 is a section view of an exemplary configuration of the gasket of the invention with the connector of FIG. 1 mounting the gasket to a structure.

FIG. 4 is a section view of the mounting body.

FIG. 5 is a section view of an alternative configuration wherein the connectors are integral or preinstalled to the mounting structure.

Similar numbers refer to similar parts throughout the specification.

### DETAILED DESCRIPTION OF THE INVENTION

In the context of this specification, the terms “gasket” and “seal” refer to a structure that extends between two structures, systems, or elements in such a way as to prevent or minimize leakage. Examples of gaskets or seals include those disposed around, under, or along the side of hatches, trunk lids, windows, and doors. The doors may be trunk lids, box lids, hatch covers, or other structures that use perimeter seals that are bent around corners or curves.

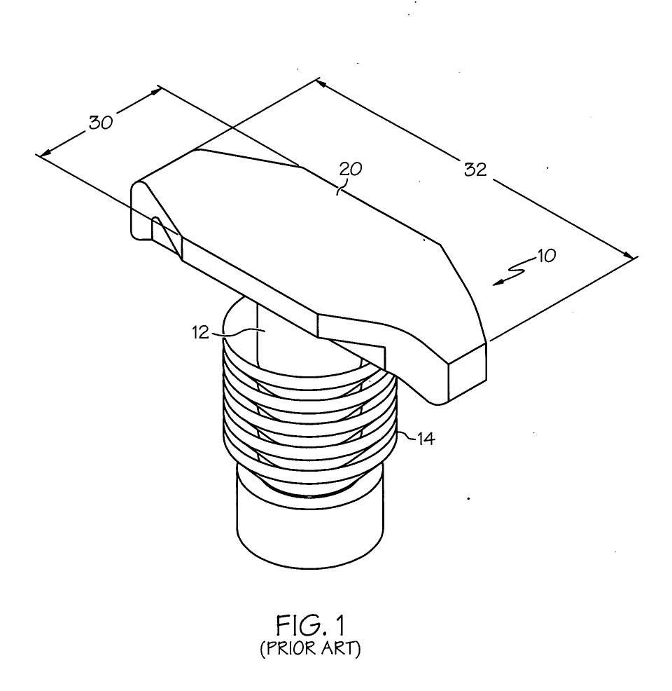

FIG. 1 depicts an exemplary prior art push-in connector 10 that generally includes a body 12 having a plurality of locking fingers 14 that allow connector 10 to be pushed into an opening 16 defined by a structure 18 in one direction and not be easily withdrawn in the opposite direction. The particular configuration of connector 10 is not critical to the invention as long as the connector includes the head and body. Connector 10 also includes a head 20 that may be broader than fingers 14. Head 20 is used to secure connector 10 to a seal.

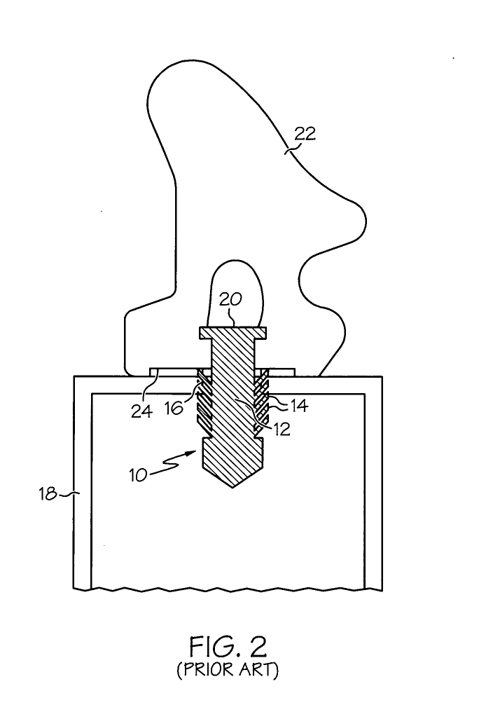

FIG. 2 shows how connector 10 may be secured to a prior art sealing body 22 of a gasket by pushing head 20 through a hole or slit defined by the lower surface 24 of sealing body 22. These holes or slits must be formed in the gasket at the exact locations where connector 10 will be needed for the installation of the gasket. The holes or slits are typically formed by hand drilled or hand punching after the gasket is extruded.

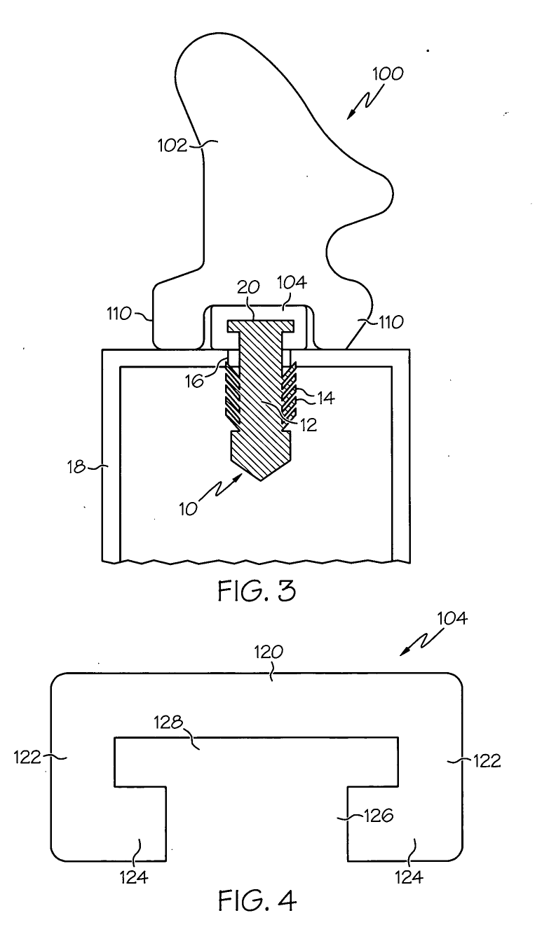

An exemplary configuration of the gasket or seal of the invention is depicted in FIG. 3 and is indicated generally by the numeral 100. Gasket or seal 100 includes a sealing body 102 secured to a mounting body 104. Body 104 is formed separately from body 102 and then joined together. Body 102 may be secured to body 104 with an adhesive, by co-extrusion, by fusing the materials together, with mechanical connectors, or by welting or welding the structures together.

Sealing body 102 may be provided in a wide variety of configurations or cross sections as necessary for the application of gasket 100. In the exemplary configuration, sealing body 102 includes a pair of shoulders 110 that are disposed on the sides of mounting body 104 to completely hide mounting body 104 from view when gasket 100 is installed. Shoulders 110 may engage structure 18 to form one seal. Also, in some configurations, shoulders 110 may not extend all of the way to structure.

Mounting body 104 includes an upper wall 120, a pair of side walls 122, and a bottom wall 124. Bottom wall 124 defines an opening 126 that may extend continuously or in elongated sections (compared to the length dimension of head 20) in the longitudinal direction of mounting body 104. Opening 126 provides access to an elongated hollow chamber 128 of mounting body 104. Chamber 128 may be continuous or disposed in elongated sections. In some configurations, chamber 128 may be defined by separated or joined sections of material that define mounting body 104. Chamber 128 and opening 126 together are generally T-shaped.

Chamber 128 is sized to receive head 20 of connector 10 while opening 126 is slightly wider than body 12 of connector but smaller than the length of head 20 such that connector 10 may be received in mounting body 104 as shown in FIG. 3. Opening 126 and chamber 128 may be sized to frictionally receive head 20 and body 12 such that a frictional force will tend to hold the position of connector 10 with respect to mounting body 104. Opening 126 is wider than the width 30 of head 20 so that head 20 may be rotated to align the length 32 of head 20 to be parallel to the longitudinal dimension of mounting body 104 and then inserted into chamber 128. Connector 10 may then be rotated to the configuration shown in FIG. 3 wherein head 20 is trapped in chamber 128 by bottom wall 124. The push-in and rotate connection is referred to as a bayonet-style connection. In another configuration, width 30 of head 20 is wider than opening 126. In such a configuration, connector 10 may be slid into the end of mounting body 104. A wide variety of connectors may be used with mounting body 104 with connector 10 being provided as exemplary configuration.

Gasket 100 may be supplied to the end user with or without connectors 10 installed. The user may then install connectors 10 as need and slide them along the length of mounting body 104 to the desired positions. Once connectors 10 are in place, the user may press connectors 10 into openings 16 defined by structure 18 to secure gasket 100 to structure 100. Even after connectors 10 are installed in openings 16, the user may slide gasket 100 back and forth with respect to structure 18 and connectors 10 to adjust the position of gasket 100.

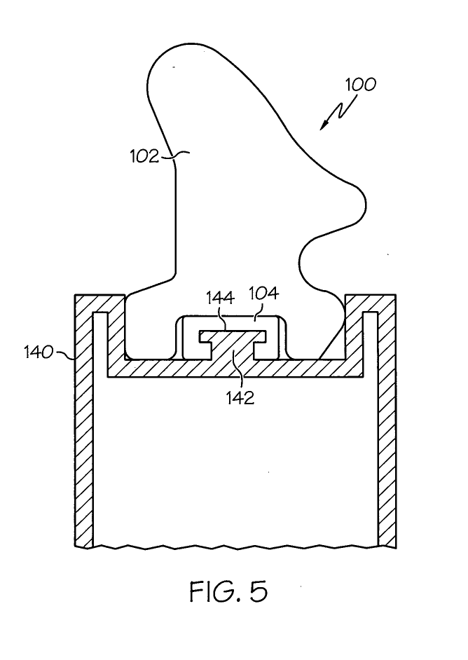

In another configuration, structure 140 includes integral or pre-installed connectors 142 that have heads 144 as shown in FIG. 5. In this configuration, the user slides gasket 100 over heads 144 to install gasket 100.

Gasket 100 is flexible so that it may be bent around corners. As such, gasket 100 may be used in applications that require a perimeter seal such as around the perimeter of an automobile trunk.

In the exemplary configuration of gasket 100, mounting body 104 may be made from polypropylene 80 R (R Scale), polypropylene 60 durometer Shore D, or 50 durometer Shore D Santoprene®. In the exemplary configuration of gasket 100, sealing body 102 may be made from 70 durometer Shore A EPDM (ethylene propylene diene Monomer (M-class) rubber), 2A2 EPDM sponge, 50 durometer Shore A ASTM D-2000-00 EPDM, 75 durometer Shore A EPDM, or ASTM D1056-00 sponge. The specific hardnesses are provided for examples of the invention. The invention broadly includes any thermoplastic elastomer (TPE) or thermoplastic (such as PP or PE) base material connected or fused to EPDM dense or sponge. The invention also broadly includes any nitrile connected to PVC.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A gasket that is adapted to be mounted to a structure with a connector having a head and a body; the gasket comprising:
a sealing body; and
a mounting body secured to the sealing body; the mounting body defining an elongated hollow chamber adapted to receive the head of the connector to connect the connector to the gasket.

2. The gasket of claim 1, wherein the sealing body includes spaced first and second shoulders with at least a portion of the mounting body disposed between the first and second shoulders.

3. The gasket of claim 2, wherein the entire mounting body is disposed between the first and second shoulders.

4. The gasket of claim 1, wherein the mounting body includes an upper wall, a pair of spaced side walls, and a bottom wall that cooperate to define the elongated hollow chamber that has a width and a depth; the bottom wall of the mounting body defining an opening.

5. The gasket of claim 4, wherein the opening is elongated.

6. The gasket of claim 4, wherein the opening is continuous.

7. The gasket of claim 4, wherein the chamber and opening are T-shaped when viewed in cross section.

8. The gasket of claim 1, wherein the sealing body and mounting body are flexible.

9. The gasket of claim 10, wherein the sealing body is softer than the mounting body.

10. A gasket comprising:
a sealing body; the sealing body being made from a first material;
a mounting body secured to the sealing body; the mounting body defining an elongated hollow chamber;
the mounting body being made from a second material different from the first material;
a connector having a head and a body; the head of the connector having a width, a length, and a thickness; and
the head of the connector being disposed in the hollow chamber with at least a portion of the body of the connector extending out of the chamber and projecting from the mounting body.

11. The gasket of claim 10, wherein the sealing body includes spaced first and second shoulders with at least a portion of the mounting body disposed between the first and second shoulders.

12. The gasket of claim 11, wherein the entire mounting body is disposed between the first and second shoulders.

13. The gasket of claim 10, wherein the mounting body includes an upper wall, a pair of spaced side walls, and a bottom wall that cooperate to define the elongated hollow chamber that has a width and a depth; the bottom wall of the mounting body defining an opening.

14. The gasket of claim 13, wherein the opening has a width that is wider than the width of the head of the connector and smaller than the length of the connector such that the connector may be mounted to the mounting body with a bayonet-style connection.

15. The gasket of claim 13, wherein the opening has a width that is smaller than the width of the head of the connector.

16. The gasket of claim 15, wherein the mounting body has an end; the hollow chamber extending out of the end of the mounting body.

17. The gasket of claim 10, wherein the head of the connector frictionally engages the mounting body such that the frictional force holds the position of head with respect to mounting body.

18. The gasket of claim 10, wherein the connector may move along the length of the mounting body.

19. A method of mounting a gasket to a structure having a plurality of preinstalled connectors with each connector having a body and a head; the method comprising the steps of:
providing a gasket having a sealing body; the sealing body being made from a first material; a mounting body secured to the sealing body; the mounting body defining an elongated hollow chamber; and the mounting body being made from a second material different from the first material; and
sliding the mounting body over the heads of the preinstalled connectors to position the heads of the connectors in the elongated hollow chamber.

20. A method of mounting a connector to a gasket comprising the steps of:
providing a gasket having a sealing body; the sealing body being made from a first material; a mounting body secured to the sealing body; the mounting body defining an elongated hollow chamber with an elongated opening; and the mounting body being made from a second material different from the first material;
providing a connector having a head and a body;
inserting the head of the connector through the opening into the elongated hollow chamber with at least a portion of the body of the connector projecting from the mounting body; and
twisting the connector to connect the connector to the gasket.
